(19) United States
(12) Patent Application Publication
(10) Pub. No.: US 2025/0193158 A1
(43) Pub. Date: Jun. 12, 2025

(54) HOMOMORPHIC ENCRYPTION OPERATION METHOD AND DEVICE

(71) Applicants: SAMSUNG ELECTRONICS CO., LTD., Suwon-si (KR); UNIST(ULSAN NATIONAL INSTITUTE OF SCIENCE AND TECHNOLOGY), Ulsan (KR)

(72) Inventors: JAEWOO PARK, Ulsan (KR); JONGEUN LEE, Ulsan (KR); HYUNGON MOON, Ulsan (KR); CHENGHAO QUAN, Ulsan (KR)

(21) Appl. No.: 18/973,410

(22) Filed: Dec. 9, 2024

(30) Foreign Application Priority Data
Dec. 11, 2023 (KR) 10-2023-0179015

(51) Int. Cl. H04L 9/40

(52) U.S. Cl. CPC H04L 63/0428

(57) ABSTRACT

Provided is a homomorphic encryption (HE) operation method. The HE operation method includes receiving an encrypted input query hyperdimensional vector (HV) from a client based on an HE technique, performing a hyperdimensional computing process including a similarity search operation on the encrypted input query HV, and transmitting a result of the hyperdimensional computing process to the client.

### CROSS-REFERENCE TO RELATED APPLICATIONS

This application is based on and claims priority under 35 USC § 119 of Korean Patent Application No. 10-2023-0179015, filed on Dec. 11, 2023, in the Korean Intellectual Property Office, the contents of which are incorporated by reference herein in their entirety.

### BACKGROUND

### 1. Field of the Invention

The following description relates to a homomorphic encryption (HE) operation method and a device, and more particularly, to an HE-based privacy-preserving machine learning (PPML) system.

### 2. Description of the Related Art

In today's digital age, ensuring the security and privacy of sensitive data while allowing for efficient computation is of paramount importance. Homomorphic encryption presents a promising solution to this challenge by enabling computations to be performed directly on encrypted data, thereby preserving data confidentiality throughout the processing pipeline. However, conventional methods and devices for homomorphic encryption often encounter privacy and performance related bottlenecks. In some examples, conventional methods are not able to ensure data privacy when dealing with large-scale datasets or complex computations.

In some cases, the computational overhead and increased resource requirements associated with conventional homomorphic operations may lead to suboptimal efficiency and scalability in practical applications. Therefore, there is a need in the art for systems and methods that can perform homomorphic encryption without compromising data security or performance.

### SUMMARY

The present disclosure describes systems and methods for homomorphic encryption (HE). Embodiments of the present disclosure include a privacy-preserving machine learning (PPML) system that prevents exposure of client data to a server. In some cases, the client may transmit, to the server, an input data encrypted based on an HE method. For example, the server may provide, to the client, an AI operation result such as a similarity search result obtained based on a hyperdimensional computing process. Accordingly, the client may decrypt and verify the operation result using the input data.

According to an aspect, there is provided a homomorphic encryption (HE) operation method of a server including receiving an encrypted input query hyperdimensional vector (HV) from a client based on an HE technique, performing a hyperdimensional computing process including a similarity search operation on the encrypted input query HV, and transmitting a result of the hyperdimensional computing process to the client.

The hyperdimensional computing process may include obtaining a plurality of normalized class HVs and performing the similarity search operation on the encrypted input query HV based on the plurality of normalized class HVs.

The performing of the similarity search operation may include generating a class matrix by combining the plurality of normalized class HVs and performing a multiplication operation on the encrypted input query HV and the class matrix.

The performing of the similarity search operation may include omitting a division operation by a class HV norm value.

The performing of the similarity search operation may include omitting a rescale operation.

The HE operation method may further include quantizing the encrypted input query HV.

The HE operation method may further include quantizing the plurality of normalized class HVs.

The result of the hyperdimensional computing process comprises a same encryption scheme as the input query HV.

The encrypted input query HV is encrypted using at least one of a Cheon-Kim-Kim-Song (CKKS) encryption scheme, a Brakerski-Gentry-Vaikuntanathan (BGV) encryption scheme, and a Brakerski/Fan-Vercauteren (BFV) encryption scheme.

According to another aspect, there is provided an encryption method including encoding the input data to obtain a HV, encrypting the HV based on an HE technique, transmitting the encrypted input query HV to a service provider, receiving a result of the hyperdimensional computing process from the service provider, wherein the hyperdimensional computing process comprises a similarity search operation on the encrypted input query HV, and decrypting the result of the hyperdimensional computing process.

According to still another aspect, there is provided an electronic device including a processor configured to receive an encrypted input query HV from a client based on an HE technique, perform a hyperdimensional computing process including a similarity search operation on the encrypted input query HV, and transmit a result of the hyperdimensional computing process to the client.

The processor may be configured to obtain a plurality of normalized class HVs and perform the similarity search operation on the encrypted input query HV based on the plurality of normalized class HVs.

The processor may be configured to generate a class matrix by combining the plurality of normalized class HVs and perform a multiplication operation on the encrypted input query HV and the class matrix.

The processor may be configured to omit a division operation by a class HV norm value.

The processor may be configured to omit a rescale operation.

The processor may be configured to quantize the encrypted input query HV and the normalized class HVs.

The result of the hyperdimensional computing process comprises a same encryption scheme as the input query HV.

The encrypted input query HV is encrypted using at least one of a CKSS encryption scheme, a BGV encryption scheme, and a BFV encryption scheme.

According to still another aspect, there is provided a method that comprises obtaining an encrypted input query hyperdimensional vector (HV) and a plurality of class HVs; selecting a modified similarity search operation based on a hyperdimensionality of the encrypted input query HV; and performing the modified similarity search operation on the encrypted input query HV and the plurality of class HVs to obtain a similarity search result.

In some aspects, the modified similarity search operation omits a division operation from a standard similarity search operation. In some aspects, the similarity search result comprises a same encryption scheme as the input query HV.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a privacy-preserving machine learning (PPML) system, according to an embodiment;

FIG. 2 illustrates an operating method of a client, according to an embodiment;

FIG. 3 illustrates an operating method of a server, according to an embodiment;

FIG. 4 illustrates of a quantization method, according to an embodiment;

FIG. 5 illustrates an inference rate according to a homomorphic encryption (HE) operation method, according to an embodiment;

FIG. 6 illustrates an operating method of a server, according to an embodiment;

FIG. 7 illustrates an operating method of a client, according to an embodiment; and

FIG. 8 illustrates a hyperdimensional computing method, according to an embodiment.

### DETAILED DESCRIPTION

The present disclosure describes systems and methods for a homomorphic encryption (HE). Embodiments of the present disclosure include a privacy-preserving machine learning (PPML) system that prevents exposure of client data to a server. In some cases, the client may transmit, to the server, an input data encrypted based on an HE method. For example, the server may provide, to the client, an AI operation result such as a similarity search result obtained based on the encrypted input data using a hyperdimensional computing process. Accordingly, the client may decrypt and verify the operation result using the input data.

Homomorphic encryption (HE) is an encryption method that enables operations between pieces of encrypted data. For example, based on the HE method, an operation may be performed in an encrypted state without decrypting encrypted data. Additionally, in some cases, HE may be considered safe (e.g., safe to use since user data/privacy may be protected) since the HE technique is lattice-based and resistant to a quantum algorithm.

In some cases, HE may be used in various artificial intelligence (AI) systems. However, a significant number of HE ciphertexts may be generated during the process of encrypting data for convolutional neural network (CNN) inference. In some cases, the generated HE ciphertexts may require high memory consumption and a large amount of network data transmission.

Accordingly, the present disclosure describes systems and methods of packing high-dimensional data, such as an image, to minimize the memory consumption and the network data transmission. An embodiment of the present disclosure describes a hyperdimensional computing structure that enables a reduction in power and cost (e.g., compared to conventionally used methods). For example, the hyperdimensional computing structure may include a similarity search algorithm that may use a small number of ciphertext.

Embodiments of the present disclosure are configured to convert a user-provided input data into a hyperdimensional vector (HV). In some cases, the client may encrypt the HV using the HE technique in the PPML system and transmit the encrypted HV to the server that performs a hyperdimensional computing operation on the received encrypted HV and provides an operation result to the client. Further, the client may verify the operation result from the server after performing a decryption process.

Accordingly, the present disclosure describes systems and methods for homomorphic encryption (HE). Embodiments of the present disclosure include a method of performing the HE comprising receiving an encrypted input query hyperdimensional vector (HV) from a client based on an HE technique. In some cases, the server performs a hyperdimensional computing process comprising a similarity search operation on the encrypted input query HV and a plurality of pre-normalized class HVs. Finally, the server transmits a result of the hyperdimensional computing process to the client.

According to an embodiment of the present disclosure, the hyperdimensional computing structure may perform a quantization of the plurality of pre-normalized class HVs and the encrypted input query HV. In some cases, the quantization in the hyperdimensional computing structure may reduce the operation precision of multiplication and ultimately increase the performance of the accelerator hardware. By performing the quantization process, embodiments of the disclosure are able to increase the HE operation rate and enhance the classification accuracy of the server even in case of an inaccurately encrypted operation of the HE.

By implementing an AI system with a hyperdimensional computing structure, embodiments of the present disclosure are able to provide a PPML service with significantly less computing resources. In some cases, the PPML service may be capable of providing a real-time service in hardware. Additionally, by implementing the hyperdimensional computing structure in the server, embodiments of the disclosure are able to maintain the confidentiality of user data.

According to an embodiment, a method comprises obtaining an encrypted input query hyperdimensional vector (HV) and a plurality of class HVs. In some cases, a modified similarity search operation may be selected based on a hyperdimensionality of the encrypted input query HV. Additionally, the server performs the modified similarity search operation on the encrypted input query HV and the plurality of class HVs to obtain a similarity search result.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Terms, such as first, second, and the like, may be used herein to describe components. Each of these terminologies is not used to define an essence, order or sequence of a corresponding component but used merely to distinguish the corresponding component from other component(s). For example, a “first” component may be referred to as a “second” component, or similarly, and the “second” component may be referred to as the “first” component within the scope of the right according to the concept of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, “directly between”, or “directly neighboring”, etc., should be interpreted to be alike.

The singular forms “a,” “an,” and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms used herein including technical or scientific terms have the same meaning as commonly understood by one of ordinary skill in the art to which examples belong. Terms, such as those defined in commonly used dictionaries, should be construed to have meanings matching with contextual meanings in the relevant art and the present disclosure, and are not to be construed as an ideal or excessively formal meaning unless otherwise defined herein.

The examples may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, examples will be described in detail with reference to the accompanying drawings. In the drawings, like reference numerals are used for like elements.

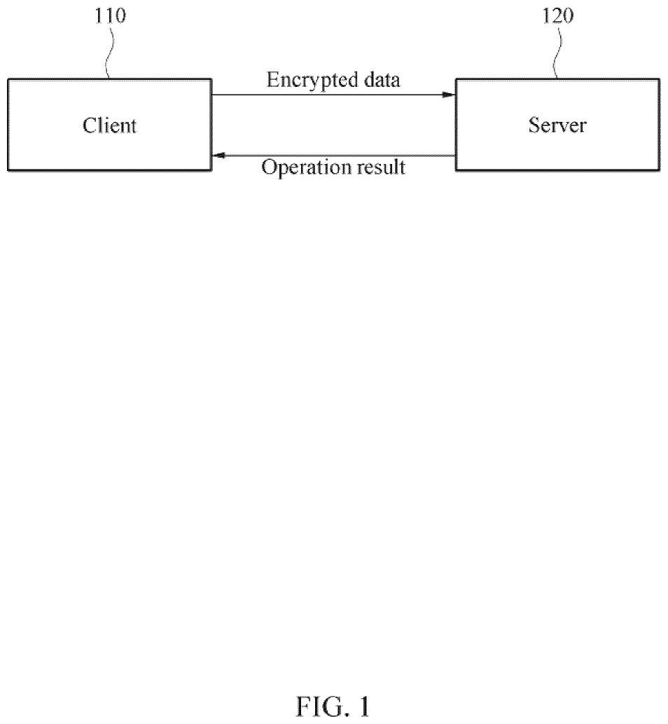

FIG. 1 illustrates a privacy-preserving machine learning (PPML) system according to an embodiment.

Referring to FIG. 1, the PPML system according to an embodiment may include a client 110 and a server 120. In some cases, the client 110 and the server 120 may be the main agents.

The PPML system may be a system that provides an artificial intelligence (AI) service from the server 120 to the client 110 without directly exposing data of the client 110 to the server 120.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data. Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, that control a degree of connections between neurons and influence the neural network's ability to capture complex patterns in data. An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Referring again to FIG. 1, the client 110 is a main agent that receives the AI service from the server 120 and may be referred to as a service-using main agent, a service user, a data owner, etc. In some cases, the client 110 may encrypt data (e.g., an image) of the client 110 based on a homomorphic encryption (HE) technique through a client terminal and may transmit the encrypted data to the server 120. For example, the client terminal may be referred to as a user terminal.

HE is encryption technology that may process the encrypted data without decrypting the encrypted data. For example, HE enables operations (such as addition, multiplication, etc.) that may be carried out directly on ciphertext (encrypted data), producing an encrypted result that, when decrypted, corresponds to the result of the operations performed on the plaintext (unencrypted) data. As such, when various operations may be performed in a homomorphic-encrypted state, the result may be the same as an operation result in an unencrypted state. Since HE may process data in an encrypted state, privacy and confidentiality issues occurring in the data industry may be resolved.

Referring to FIG. 1, the server 120 may receive the encrypted data from the client 110 and transmit an AI operation result corresponding to the encrypted data to the client 110. In some cases, the server 120 may be referred to as a service provider, a service-providing main agent, etc.

A server provides one or more functions to a set of linked users. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

According to an embodiment, the server 120 may provide an AI service based on hyperdimensional computing (HDC). In case of hyperdimensional computing, data may be encoded into high-dimensional vectors, and computations may be performed using operations in the high-dimensional vector space. For example, the HDC vectors may be sparse and include a small number of non-zero elements. Further, information may be distributed across the entire vector space, rather than localized to specific elements, enabling robustness to noise and partial input. Accordingly, by leveraging high-dimensional vector spaces for information representation and processing, HDC methods may be used for developing robust and efficient AI systems.

In some cases, the AI service based on hyperdimensional computing may be an algorithm low power and low cost compared to AI in a deep neural network (DNN) method. When the encrypted data is processed based on the HE technique, the amount of operations and execution time may be significantly reduced when a hyperdimensional computing structure is used instead of a DNN.

Additionally, an HE operation may support batching, multiplication, and rotation operations that change order in the same encryption. Accordingly, the execution time may increase in the order of batching, multiplication, and rotation operations.

HE may have a predetermined degree of a polynomial as a parameter. In some cases, the degree may be a power of 2. In some cases, the execution time of the operations increases exponentially as the degree of a polynomial increases. Additionally, a high number (and variety) of operations may be supported and the precision of a calculation may increase with increase in the degree of a polynomial.

The HE operation may perform HE multiplication by a predetermined maximum number of multiplications. In some cases, the time required for an HE operation may exponentially increase as the maximum number of multiplications increases. Simultaneously, the maximum number of multiplications may be limited to the degree of a polynomial and the maximum number of multiplications may increase as the degree of a polynomial increases. Thus, a rate of the HE operation increases as the number of HE multiplication operations reduces.

According to a related art, an AI system based on a complex nonlinear activation function and a DNN requiring multiple multiplications and batching may be extremely slow (e.g., a few seconds to 3,000 seconds) since the AI system is used in an actual service. Additionally, in some cases, an AI system (such as a support vector machine) may use less number of operations than a DNN. However, such an AI system may include extremely low classification accuracy and limited usability.

According to an embodiment, an AI system having a hyperdimensional computing structure may implement a similarity search algorithm for inference. The similarity search algorithm may perform an operation on the HE extremely quickly since the similarity search algorithm uses only one performance of HE-ciphertext-plaintext multiplication, HE rotation, and batching. In some cases, the similarity search algorithm may include classification accuracy equivalent to a DNN (e.g., in comparison with other AI algorithms).

Accordingly, the AI system of the present disclosure, comprising a hyperdimensional computing structure may provide a PPML service. In some cases, the PPML service may be capable of providing a real-time service in hardware that may generally be used instead of the existing DNN-based PPML system that requires significant computing resources. According to an embodiment, the AI system with a hyperdimensional computing structure may be used when confidentiality of user data, such as face recognition or mask detection, is significant.

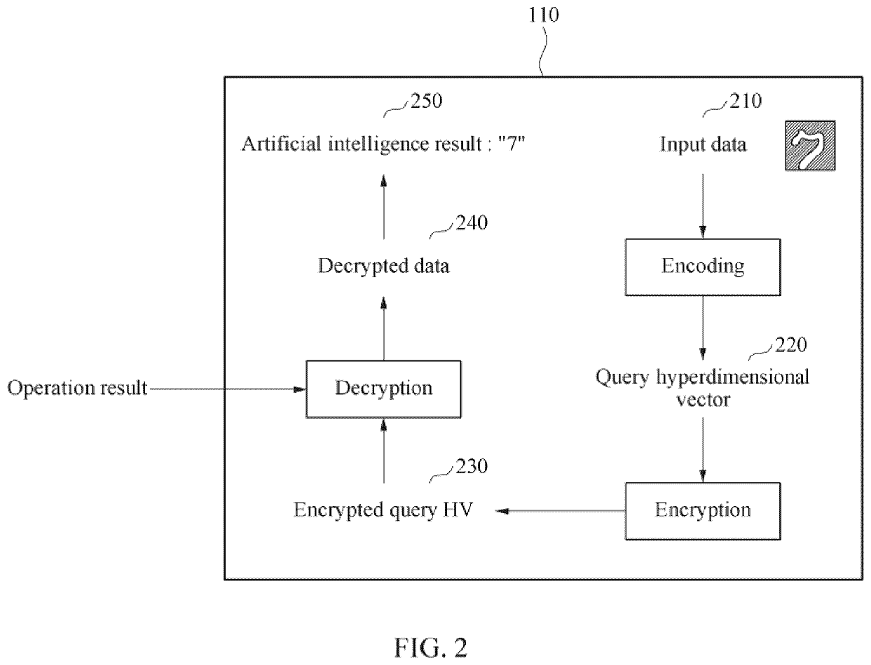

FIG. 2 illustrates an operating method of a client, according to an embodiment. The description provided with reference to FIG. 1 may also apply to FIG. 2.

Referring to FIG. 2, the client 110 may convert input data 210 into a hyperdimensional vector (HV). The input data 210 may, for example, be personal data of a user. The client 110 may convert the input data 210 into the HV using a hyperdimensional encoder. In some cases, the HV 220 as the conversion result of the encoding process may be referred to as a query HV 220.

According to an embodiment, the input data 210 may be mapped from an input space to an HV space based on an encoding function (e.g., φ: X→H). In some cases, a linear classifier may not operate appropriately (e.g., accurately) among pieces of complex data. In some cases, when the input data 210 is mapped with a high dimension, a hyperplane that divides the input data 210 may be successfully found. Hyperdimensional computing may represent the input data 210 as an HV and thus simplify a classification processor. In some cases, an encoder may encode the input data 210 into the query HV 220 with a high dimension (e.g., 4k to 8k).

The client 110 may encrypt the HV using the HE technique. In case of the HE technique, an operation result using ciphertext may become new ciphertext. Additionally, plaintext obtained by decrypting the ciphertext may be the same as an operation result of original data before performing encryption. Hereinafter, the encrypted data or ciphertext may be referred to as ciphertext. The ciphertext may be in the form of a polynomial or a vector including the polynomial.

The client terminal may perform an encryption process that encrypts the input data 210 in the PPML system. In some cases, the client terminal may be implemented as a chip and may be mounted on a hardware accelerator that uses HE. In some cases, the client terminal may be implemented as a chip or software and may reduce memory usage in various operation devices. In some cases, the client terminal may reduce the total amount of operations of the server 120 (described in FIG. 1) by reducing the number of operations of the HE.

In some cases, the client terminal may be applied to any HE based on a ring learning with error (RLWE) problem. The client terminal may be implemented in an encryption process that encrypts an input value in the devices and services to which HE is applied.

Ring Learning with Errors (RLWE) extends the Learning with Errors (LWE) problem to polynomial rings modulo integers. It involves sampling polynomials with random coefficients and adding a noise term to each coefficient. The goal is to compute a noisy polynomial based on a given set of random and noisy polynomials. RLWE may be fundamental in lattice-based cryptography, providing quantum-resistant cryptographic schemes like public-key encryption and key exchange. By efficient implementation of the RLWE based on careful parameter selection and optimization, RLWE may be used for post-quantum cryptography.

Learning with Errors (LWE) is foundational in lattice-based cryptography that includes solving random linear equations where a secret vector is combined with noisy terms. For example, in case of the LWE, a secret vector may be recovered from noisy observations. In some cases, LWE may be used to design secure cryptographic schemes resistant to quantum attacks, offering alternatives to traditional algorithms vulnerable to quantum computing threats. Efficient LWE-based implementations require careful parameter selection and optimization for practical cryptography applications.

The client terminal that performs the encryption may be implemented in a personal computer (PC), data server, or portable device. The portable device may be implemented as, for example, a laptop computer, mobile phone, smartphone, tablet PC, mobile internet device (MID), personal digital assistant (PDA), enterprise digital assistant (EDA), digital still camera, digital video camera, portable multimedia player (PMP), personal or portable navigation device (PND), handheld game console, e-book, or smart device. The smart device may be implemented as, for example, a smartwatch, smart band, or smart ring.

The client 110 may transmit an encrypted query HV 230 to the server 120. The server 120 may return an operation result to the client 110 after performing an operation with the encrypted query HV 230. For example, the server 120 may perform a similarity search operation with the encrypted query HV 230.

The client 110 may decrypt the operation result received from the server 120. The client 110 may verify an AI result 250 provided by the server 120 based on decrypted data 240. For example, the client 110 may verify a classification result (e.g., “7”) of AI by decrypting a similarity search result.

In some cases, the client terminal may include processing in memory (PIM). The client terminal may perform an operation (hereinafter, referred to as an HV encoding operation) that converts the input data 210 into an HV and an operation (hereinafter, referred to as an HE encryption operation) that encrypts the HV by using the PIM.

Processing-in-memory (PIM) is a computing paradigm where computation tasks are performed within memory modules, rather than relying solely on separate central processing units (CPUs). In PIM architectures, memory units are equipped with processing elements (such as arithmetic/logic units) to execute computations directly on data stored in memory. The approach aims to reduce data movement between memory and processing units, thereby improving performance and energy efficiency for various computational tasks. Additionally, the co-location of computation and data accelerates processing and reduces latency for memory-intensive applications.

The HV encoding operation refers to an operation that converts the input data 210 into an HV. For example, when the input data 210 is an image (i.e., a photo), the image may be converted into a vector with a high dimension by multiplying the image by a random matrix. In some cases, the client terminal may perform the HV encoding operation in the PIM since the PIM supports a matrix multiplication operation.

In some examples, the HE encryption operation may include a matrix multiplication operation, fast Fourier transform (FFT) operation, or number-theoretic transform (NTT) operation. In some cases, matrix multiplication may refer to a mathematical operation that combines two matrices to produce a third matrix, representing the composition of linear transformations. For example, the resulting matrix's elements may be computed by taking dot products of rows from the first matrix with columns from the second matrix. In some cases, the FFT operation includes an algorithm that computes discrete Fourier transform (DFT) of a sequence of data points, transforming the data from the time or spatial domain to the frequency domain. For example, the FFT algorithm may reduce the computational complexity of the DFT for use in applications requiring spectral analysis. In some cases, the NTT may be an algorithm that transforms a complex number operation of FFT into an integer modular operation. For example, the matrix multiplication operation, FFT operation, and NTT operation may each be performed in the PIM.

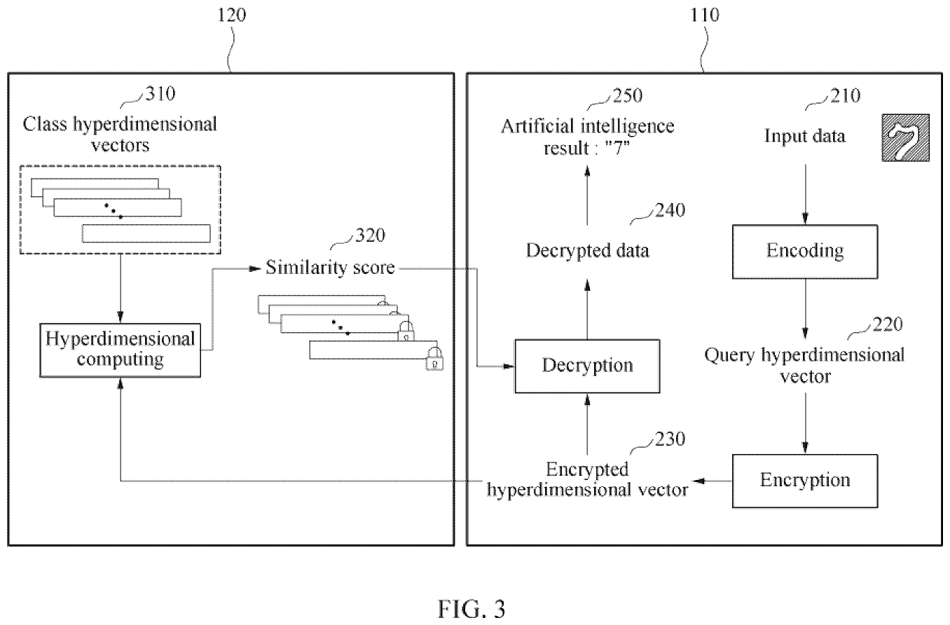

FIG. 3 illustrates an operating method of a server, according to an embodiment. The description provided with reference to FIGS. 1 and 2 may also apply to FIG. 3.

Referring to FIG. 3, the server 120 according to an embodiment may receive the encrypted query HV 230 from the client 110. The server 120 may perform a hyperdimensional computing operation with the encrypted query HV 230. For example, the server 120 may process a classification task through hyperdimensional computing. The server 120 may perform a similarity search operation on class HVs 310 that are labeled and the encrypted query HV 230 received from the client 110. For example, the server 120 may perform a similarity search operation based on a cosine similarity between the class HVs 310 that are labeled and the encrypted query HV 230. The server 120 may determine a similarity score 320 based on the similarity search operation result.

According to an embodiment, the similarity search operation may be much faster than an operation of a DNN. Furthermore, the server 120 may perform a similarity search operation in which a division operation and rescale operation may be skipped in a hyperdimensional computing system. Accordingly, by performing a similarity search operation in which a division operation and rescale operation are skipped, embodiments of the present disclosure are able to protect user data based on HE.

In some cases, conventional systems may perform a similarity search in low-power hardware, neuromorphic hardware, or PIM hardware. Additionally, the similarity search may be used based on an optimization (e.g., by being optimized) for each piece of target hardware. However, such methods are not able to perform a similarity search algorithm optimized for the HE.

According to an embodiment of the present disclosure, a similarity determination operation may optimize a similarity operation that may include a multiplication operation and a nonlinear operation. In some cases, the nonlinear operation may suit HE by extremely precisely analyzing characteristics of the HE operation. Accordingly, for example, the operation rate may be enhanced by 30% while maintaining the accuracy of the operation result.

A similarity search algorithm used in an AI classifier based on a hyperdimensional computing structure may be expressed as Equation 1 below.

$$δ ( {\vec{ℋ}}_{q} , {\vec{𝒞}}^{l} ) = \frac{{\vec{ℋ}}_{q}^{T} \cdot {\vec{𝒞}}^{l}}{‖ {\vec{ℋ}}_{q} ‖ \cdot ‖ {\vec{𝒞}}^{l} ‖} \qquad [ Equation 1 ]$$

According to a related art, referring to Equation 1, the similarity search algorithm returns a result of dividing an extremely long HV (e.g., the HV refers to a vector with at least 2,000 dimensions) inner product by L2 norm of two vectors. However, embodiments are not limited thereto, and in some examples, the hyperdimensional vector may include a significantly high number (e.g., tens of thousands) of dimensions. Referring to Equation 1, Hg denotes an input query HV associated with (e.g., a query that may want to know) a classification result and Cl is a weight of an AI model and denotes a class HV.

In some cases, the similarity search operation method may pre-normalize and store a class HV to avoid multiplication since most HE techniques may not support division and may be slow in performing a multiplication operation. Additionally, the absolute value of the similarity result is not important to know the classification result since only the maximum value of the similarity result with several class HVs may be known. Additionally, when the relative magnitude is preserved, there may be no problem in correctly calculating an inference result. Accordingly, as shown in Equation 2, the similarity search operation method may skip an operation of dividing an input query HV by L2norm.

$$δ ( {\vec{ℋ}}_{q} , {\vec{𝒞}}^{l} ) = \frac{{\vec{ℋ}}_{q}^{T} \cdot {\vec{𝒞}}^{l}}{‖ {\vec{ℋ}}_{q} ‖ \cdot ‖ {\vec{𝒞}}^{l} ‖} = \frac{{\vec{ℋ}}_{q}^{T} \cdot {\vec{𝒞}}^{′ l}}{‖ {\vec{ℋ}}_{q} ‖} \qquad [ Equation 2 ]$$

Similarly, in case of Cheon-Kim-Kim-Song (CKKS) HE, the similarity search operation method may skip a rescale operation to preserve a place of the decimal point of multiplication after performing multiplication.

As referred to herein, the Cheon-Kim-Kim-Song (CKKS) may be a homomorphic encryption (HE) scheme that is a variant of the Ring Learning with Errors (RLWE) encryption scheme, and is designed for secure computation on encrypted data in the context of real numbers and complex numbers. For example, the CKSS may employ parameter tuning and optimization strategies to achieve scalable and efficient homomorphic computation on real and complex numbers. In some cases, the CKKS may be performed by extending the RLWE framework to operate over the ring of polynomials with coefficients in a complex number field. In some examples, the CKSS may leverage techniques such as modulus switching and approximate encoding to handle scaling and precision in HE. In some cases, the CKSS may enable computations on encrypted data without the need for decryption, preserving data privacy and confidentiality.

For an efficient similarity search of hyperdimensional computing, one class matrix may be formed by combining class HVs, as shown in Equation 3, and the similarity search operation may be simplified to one matrix product, as shown in Equation 4.

$$M = [ \begin{matrix}{\vec{𝒞}}^{′1} & {\vec{𝒞}}^{′2} & … & {\vec{𝒞}}^{′ L}\end{matrix} ] \qquad [ Equation 3 ]$$

$$\vec{δ} ( {\vec{ℋ}}_{q} , M ) = {\vec{ℋ}}_{q}^{T} \cdot M \qquad [ Equation 4 ]$$

An embodiment of the present disclosure includes systems and methods to enhance an inference rate. For example, referring to Table 1, the inference rate may be improved (e.g., 30% higher than existing similarity search algorithm) in the similarity search operation method while maintaining the operation accuracy.

TABLE 1

| Method | Inference Latency (ms) |
|---|---|
| Without Normalization and with Rescale^{†} | 257.37 (×1.30) |
| Without Normalization (Rescale Skipped) | 214.75 (×1.09) |
| With Normalization (Rescale Skipped) | 197.41 (×1) |

Note.
1. N = 8192 and D = 4096.
2. ^{†}Requires a longer modulus chain.

The server 120 may transmit a result of performing the hyperdimensional computing operation to the client 110. For example, the server 120 may transmit the similarity score 320 to the client 110.

The server 120 may be implemented as a computer device or a plurality of computer devices that communicates with the client 110 through a network and provides instructions, code, files, content, services, etc. The server 120 may provide an AI service to the client 110. For example, the server 120 may provide a classification task service, etc. However, the service provided by the server 120 is not limited to the examples above and may include other services associated with AI.

A communication method between the server 120 and the client 110 may not be limited and may include a communication method using a communication network (e.g., a mobile communication network, wired Internet, wireless Internet, broadcasting network, etc.). In some cases, the communication network may be included in a network and a short-distance wireless communication method may exist between devices. For example, the network may include one or more networks, such as a personal area network (PAN), local area network (LAN), campus area network (CAN), metropolitan area network (MAN), wide area network (WAN), broadband network (BBN), the Internet, and the like. In addition, the network may include, but is not limited to, one or more topologies, including a bus network, star network, ring network, mesh network, star-bus network, tree or hierarchical network, etc.

The server 120 may include a PIM. The server 120 may perform the hyperdimensional computing operation (e.g., the similarity search operation) optimized for the HE described using the PIM.

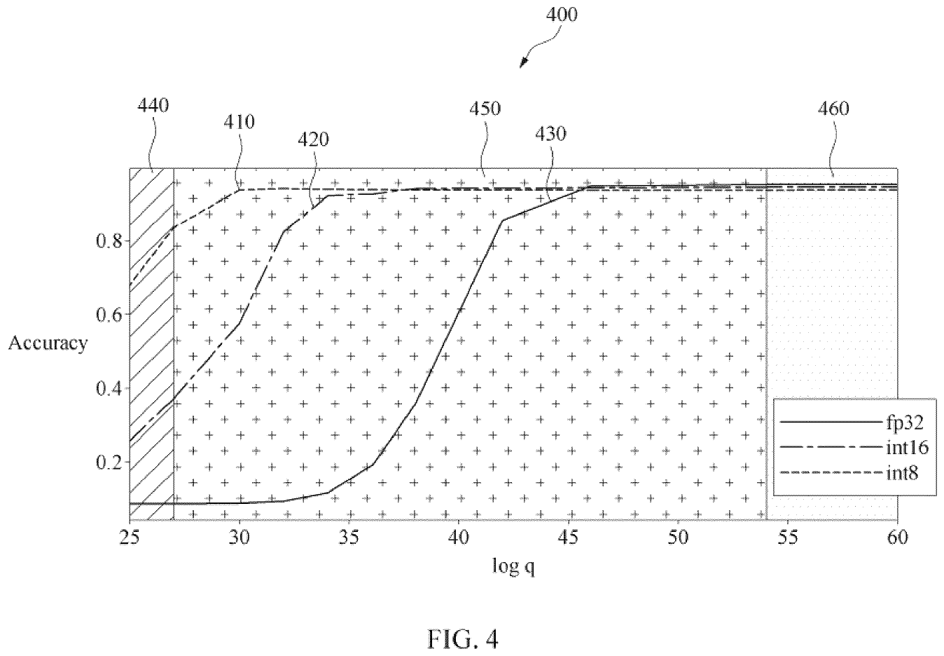

FIG. 4 is a diagram illustrating of a quantization method according to an embodiment. The description provided with reference to FIGS. 1 to 3 may also apply to FIG. 4.

According to an embodiment, a PPML system may quantize (e.g., use a 32-bit/16-bit integer type instead of a 32-bit floating decimal point type) a class HV and a query HV.

The quantization in the hyperdimensional computing structure may reduce the operation precision of multiplication to improve the performance of accelerator hardware (e.g., a PIM accelerator). However, none of the conventional techniques can be used to perform quantization to ultimately increase the HE operation rate. In some cases, the HE operation rate may be increased by lowering the degree of a polynomial of the HE operation or using quantization to improve the classification accuracy of AI in the inaccurately encrypted operation of the HE.

The HE operation may include a slow operation rate and high operation accuracy as types of supportable operations are complex (i.e., according to parameters). According to an embodiment, the PPML system may provide a quantization method that maintains high classification accuracy for a fast operation even with low operation precision. Therefore, the PPML system may accelerate the operation rate without compromising the security level of the HE.

In case of conventional systems, the operation rate may increase as the degree of a polynomial of the HE decreases. However, simultaneously, the operation accuracy may decrease when performing decryption due to the limited operation precision and limited types of operation of the HE. In some cases, the HE may accumulate errors as operations may be repeated.

Referring to FIG. 4, a graph 400 illustrates a decrease in the accuracy of an AI classifier based on hyperdimensional computing when the operation precision decreases. Data series 410 illustrates inference accuracy based on the degree of a polynomial when the operation precision of the HE is int8. Additionally, data series 420 illustrates inference accuracy based on the degree of a polynomial when the operation precision of the HE is int16. Additionally, data series 430 illustrates inference accuracy based on the degree of a polynomial when the operation precision of the HE is fp32. Further, a first region 440 may refer to a region that may be expressed as the degree of an HE polynomial of 2,048. Additionally, a second region 450 may refer to a region that may be expressed as the degree of an HE polynomial of 4,096. Additionally, a third region 460 may refer to a region that may be expressed as the degree of an HE polynomial of 8,192.

According to an embodiment, a server may quantize a class HV corresponding to an AI model to secure high classification accuracy from low operation precision. In some cases, a client may quantize an encrypted input query HV. For example, referring to the data series 410 and data series 430 in FIG. 4, the class HV may have significantly higher classification accuracy than conventional floating decimal point (fp32) when the class HV is quantized with int8 (e.g., even in case of extremely low operation accuracy).

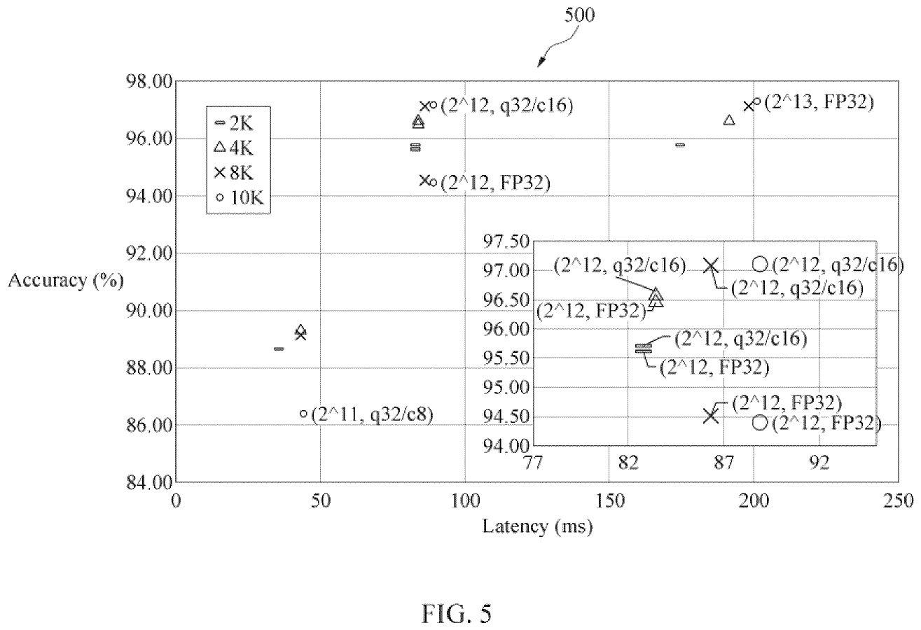

FIG. 5 illustrates an inference rate according to an HE operation method, according to an embodiment.

Referring to FIG. 5, an x-axis of a graph 500 may refer to inference latency (unit: ms) and a y-axis of the graph 500 may refer to inference accuracy (%). Referring to graph 500, a point (a, b), ‘a’ may refer to the degree of an HE polynomial. In some cases, ‘b’ may refer to a quantization level (e.g., operation precision). The index in graph 500 depicts 2k, 4k, 8k, and 10k which may each refer to the number of dimensions of an HV. In case of the quantization level (e.g., operation precision), q32/c16 may refer to the quantization of fp32 to int16 and q32/c8 may refer to the quantization of fp32 to int8.

As shown in FIG. 5, a classification operation may be performed within 0.083 seconds with a similar level of classification accuracy (97.10%) as a DNN, when the degree of HE polynomial of 4,096, an HV dimension of 4,096, and a class HV quantized to a 16-bit integer are used.

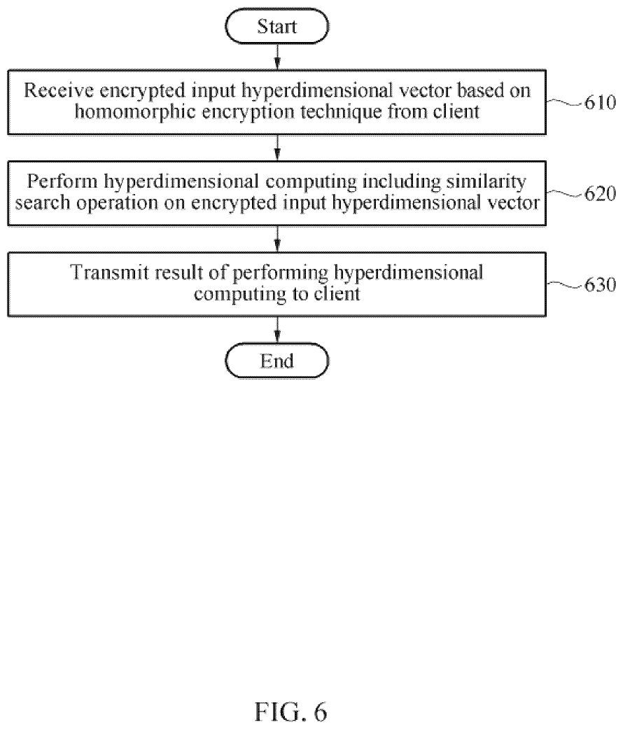

FIG. 6 illustrates an operating method of a server, according to an embodiment. The description provided with reference to FIGS. 1 to 5 may also apply to FIG. 6.

For ease of description, operations 610 to 630 are described as being performed by the server 120 (as described with reference to FIG. 1). However, embodiments are not limited thereto and operations 610 to 630 may be performed by another suitable electronic device in a suitable system.

Furthermore, operations of FIG. 6 may be performed in the order and manner shown in the figure. However, the order of some operations may be changed or omitted without departing from the spirit and scope of the disclosure. In some cases, the operations shown in FIG. 6 may be performed in parallel or simultaneously.

In operation 610, a server (e.g., the server 120 described with reference to FIG. 1) may receive an encrypted input query HV based on the HE technique from a client. For example, the server may receive an encrypted input query HV based on CKKS. Additionally or alternatively, in some examples, the server may receive an encrypted input query HV based on at least one of Brakerski-Gentry-Vaikuntanathan (BGV) and Brakerski/Fan-Vercauteren (BFV).

As disclosed herein, the BGV scheme may be a variant of homomorphic encryption designed to support operations on encrypted data within a certain polynomial ring structure. In some cases, the BGV enables homomorphic addition and multiplication operations on encrypted messages, providing for privacy-preserving computations. Additionally, the BFV scheme is a variant of homomorphic encryption that extends the capabilities of the BGV scheme for applications involving real-number arithmetic. In some cases, the BFV may introduce techniques that handle noise growth and manage ciphertext sizes more effectively. Each of the BGV and BFV schemes may be homomorphic encryption techniques based on lattice-based cryptography that enable secure and efficient computations on encrypted data, contributing to the development of privacy-enhancing technologies and secure data processing.

In operation 620, the server may perform hyperdimensional computing including a similarity search operation on the encrypted input query HV. In some cases, the server may obtain normalized class HVs and may perform the similarity search operation on the encrypted input query HV based on the normalized class HVs. For example, the server may generate one class matrix by combining the normalized class HVs and may perform the similarity search operation based on performing a multiplication operation on the encrypted input query HV and the one class matrix.

The server may skip an operation of dividing the encrypted input query HV by L2Norm when the similarity search operation is performed. In addition, the server may skip a rescale operation when the similarity search operation is performed. The server may quantize the encrypted input query HV and/or the normalized class HVs.

In operation 630, the server may transmit a result of performing the hyperdimensional computing to the client.

In some cases, the server may provide an HE-based PPML service using the hyperdimensional computing that may be performed in a realistic time at a low cost. According to an embodiment, the server may reduce execution time by 26 to 3,000 times (e.g., compared to existing DNN-based HE algorithm) by optimizing the hyperdimensional computing structure for HE based on the central processing unit (CPU) execution.

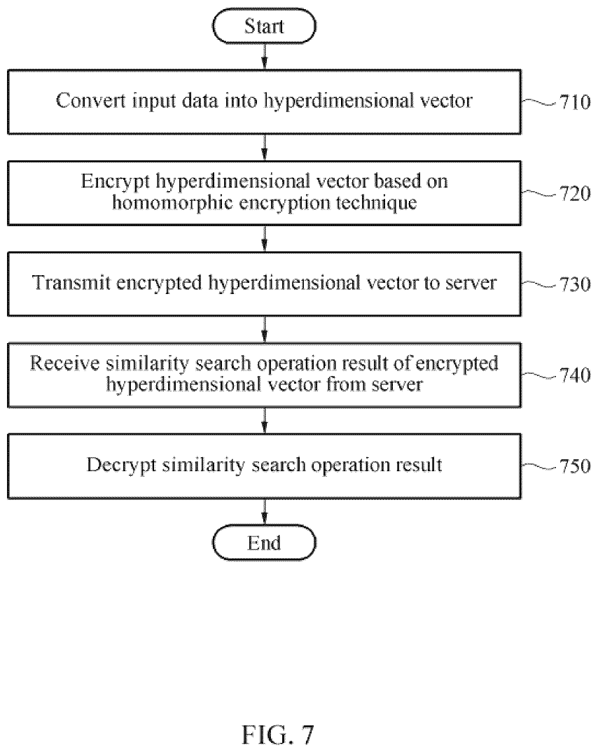

FIG. 7 illustrates an operating method of a client, according to an embodiment. The description provided with reference to FIGS. 1 to 6 may also apply to FIG. 7.

For ease of description, operations 710 to 750 are described as being performed by the client 100 illustrated in FIG. 1. However, embodiments are not limited thereto and operations 710 to 750 may be performed by another suitable electronic device in a suitable system.

Furthermore, the operations of FIG. 7 may be performed in the order and manner shown in the drawing. However, embodiments may not be limited thereto and the order of some operations may be changed or omitted without departing from the spirit and scope of the shown embodiment. The operations shown in FIG. 7 may be performed in parallel or simultaneously.

In operation 710, a client may convert input data into an HV. The client may convert the input data into an HV using an encoder. In some cases, the encoder may be an encoder based on intention, however, embodiments are not limited thereto. For example, the encoder may be an encoder that is not based on randomness.

In operation 720, the client may encrypt the HV based on the HE technique. According to an example, the client may encrypt the HV based on a CKKS-based HE. However, the encryption method is not limited to CKKS-based HE. For example, according to an embodiment, the encryption method may include a method, such as BGV, BFV, n-th degree truncated polynomial ring unit (NTRU), etc., based on HE that simultaneously supports multiple multiplications and batching.

In operation 730, the client may transmit the encrypted HV to a server (e.g., a service provider).

In operation 740, the client may receive a similarity search operation result of the encrypted HV from the server. For example, the client may receive the similarity search operation result (e.g., a similarity score) from the server.

In operation 750, the client may decrypt the similarity search operation result. In some cases, the client may verify a task result (e.g., a classification result) provided by an AI service by decrypting the similarity search result.

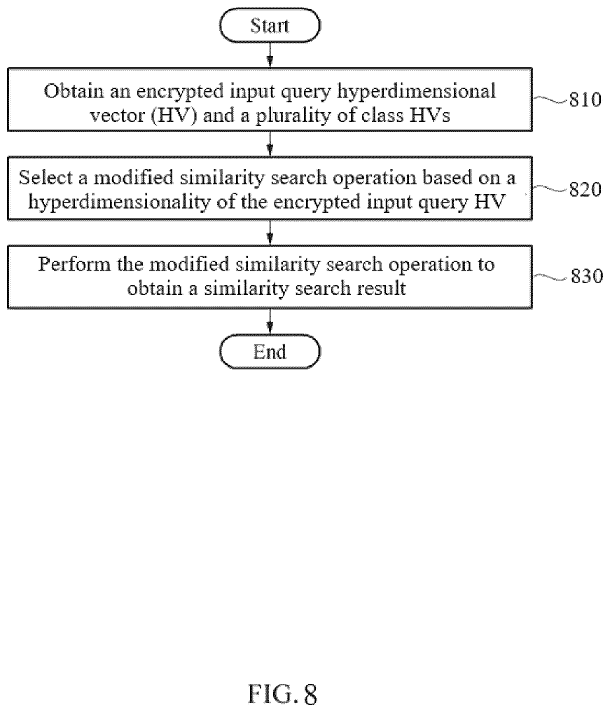

FIG. 8 illustrates an operating method, according to an embodiment. The description provided with reference to FIGS. 1 to 5 may also apply to FIG. 8.

Furthermore, the operations of FIG. 8 may be performed in the order and manner shown in the drawing. However, embodiments may not be limited thereto and the order of some operations may be changed or omitted without departing from the spirit and scope of the shown embodiment. The operations shown in FIG. 8 may be performed in parallel or simultaneously.

In operation 810, the system obtains an encrypted input query hyperdimensional vector (HV) and a plurality of class HVs. In some cases, the operations of this step refer to, or may be performed by, the server as described with reference to FIGS. 1-3. In some cases, the server may receive the encrypted data from the client. In some cases, the server may obtain a plurality of pre-normalized class HVs and store the class HVs. For example, the server may obtain a plurality of class HVs that are labeled. Further details regarding this step are provided with reference to FIGS. 2-3.

In operation 820, the system selects a modified similarity search operation based on a hyperdimensionality of the encrypted input query HV. In some cases, the operations of this step refer to, or may be performed by, the server as described with reference to FIGS. 1-3. In some examples, the server may select a similarity search operation that may skip a division operation (as described with reference to Equation 2). Additionally or alternatively, in some examples, the server may select a similarity search operation that may skip a rescale operation. Details regarding the selection of the modified similarity search operation are described with reference to FIG. 3.

In operation 830, the system is configured to perform the modified similarity search operation to obtain a similarity search result. In some cases, the operations of this step refer to, or may be performed by, the server as described with reference to FIGS. 1-3. In some cases, the server may perform a similarity search operation between the class HVs that are labeled and the encrypted input query HV. In some cases, the server may determine a similarity score based on the similarity search operation result. According to an embodiment, the server may transmit the similarity search result, such as the similarity score, to the client.

The examples described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

The disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

Accordingly, other implementations are within the scope of the following claims.

What is claimed is:

1. A homomorphic encryption (HE) operation method of a server, the method comprising:
receiving an encrypted input query hyperdimensional vector (HV) from a client based on an HE technique;
performing a hyperdimensional computing process comprising a similarity search operation on the encrypted input query HV; and
transmitting a result of the hyperdimensional computing process to the client.

2. The HE operation method of claim 1, wherein the hyperdimensional computing process comprises:
obtaining a plurality of normalized class HVs; and
performing the similarity search operation on the encrypted input query HV based on the plurality of normalized class HVs.

3. The HE operation method of claim 2, wherein the performing of the similarity search operation comprises:
generating a class matrix by combining the plurality of normalized class HVs; and
performing a multiplication operation on the encrypted input query HV and the class matrix.

4. The HE operation method of claim 2, wherein the performing of the similarity search operation comprises omitting a division operation by a class HV norm value.

5. The HE operation method of claim 2, wherein the performing of the similarity search operation comprises omitting a rescale operation.

6. The HE operation method of claim 1, further comprising:
quantizing the encrypted input query HV.

7. The HE operation method of claim 2, further comprising:
quantizing the plurality of normalized class HVs.

8. The HE operation method of claim 1, wherein the result of the hyperdimensional computing process comprises a same encryption scheme as the input query HV.

9. The HE operation method of claim 1, wherein the encrypted input query HV is encrypted using at least one of a Cheon-Kim-Kim-Song (CKKS) encryption scheme, a Brakerski-Gentry-Vaikuntanathan (BGV) encryption scheme, and a Brakerski/Fan-Vercauteren (BFV) encryption scheme.

10. A method comprising:
encoding the input data to obtain a hyperdimensional vector (HV);
encrypting the HV based on a homomorphic encryption (HE) technique;
transmitting the encrypted input query HV to a service provider;
receiving a result of the hyperdimensional computing process from the service provider, wherein the hyperdimensional computing process comprises a similarity search operation on the encrypted input query HV; and
decrypting the result of the hyperdimensional computing process.

11. A non-transitory computer-readable storage medium storing instructions that, when executed by a processor, cause the processor to perform the method of claim 1.

12. An electronic device comprising:
a processor configured to receive an encrypted input query hyperdimensional vector (HV) from a client based on a homomorphic encryption (HE) technique, perform a hyperdimensional computing process comprising a similarity search operation on the encrypted input query HV, and transmit a result of the hyperdimensional computing process to the client.

13. The electronic device of claim 12, wherein the processor is configured to:
obtain a plurality of normalized class HVs; and
perform the similarity search operation on the encrypted input query HV based on the plurality of normalized class HVs.

14. The electronic device of claim 13, wherein the processor is configured to:
generate a class matrix by combining the plurality of normalized class HVs; and
perform a multiplication operation on the encrypted input query HV and the class matrix.

15. The electronic device of claim 12, wherein the processor is configured to omit a division operation by a class HV norm value.

16. The electronic device of claim 12, wherein the processor is configured to omit a rescale operation.

17. The electronic device of claim 13, wherein the processor is configured to quantize the encrypted input query HV and the normalized class HVs.

18. The electronic device of claim 12, wherein the result of the hyperdimensional computing process comprises a same encryption scheme as the input query HV.

19. The electronic device of claim 12, wherein the encrypted input query HV is encrypted using at least one of a Cheon-Kim-Kim-Song (CKKS) encryption scheme, a Brakerski-Gentry-Vaikuntanathan (BGV) encryption scheme, and a Brakerski/Fan-Vercauteren (BFV) encryption scheme.
